(19) United States
(12) Patent Application Publication
(10) Pub. No.: US 2026/0370678 A1
(43) Pub. Date: Nov. 19, 2026

(54) COMPROMISED APPLICATION DETECTION PROPAGATION

(71) Applicant: International Business Machines Corporation, Armonk, NY (US)

(72) Inventors: Dominic Tomkins, Alton (GB); Evelyn Marie Perez, Winchester (GB); Timothy Andrew Moran, Southampton (GB); Eric John Bartlett, Chard (GB); MILES MULHOLLAND, Eastleigh (GB)

(73) Assignee: International Business Machines Corporation, Armonk, NY (US)

(21) Appl. No.: 18/613,514

(22) Filed: Mar. 22, 2024

(51) Int. Cl. H04L 9/40

(52) U.S. Cl. CPC H04L 63/1441; H04L 63/1416

(57) ABSTRACT

An embodiment receives an application tag identifying a workload received from an application. The embodiment samples application workload data related to the application. The embodiment compares the workload data sampled to an expected workload pattern. The embodiment detects behavior corresponding to the application based on a result of comparing the workload data sampled to the expected workload pattern. The embodiment issues a security categorization for the application tag corresponding to the component of the application based at least in part on the behavior detected. The embodiment propagates the security categorization issued for the application tag to a set of storage controllers. The embodiment executes a responsive action based at least in part on the security categorization issued for application tag corresponding to the component of the application.

### BACKGROUND

The present invention relates generally to network security. More particularly, the present invention relates to compromised application detection propagation.

Application tagging practices involve associating specific labels or tags with different components, tasks, or processes within an application or system. These tags provide a way to categorize and identify various elements of the workflow, enabling monitoring, analysis, and management of a system. Each component, module, or service involved in a workflow may be assigned a unique tag. Further, tags enable granular tracking of specific actions or events within the workflow. By tagging individual tasks or processes, monitoring tools can provide detailed insights into the performance and behavior of each component.

There are various practices for detecting malicious activity in a network environment. These practices for detecting malicious activity in a network environment typically include collecting data representative of usual behavior over a network, and detecting anomalous behavior by monitoring network activity and comparing network activity data collected at a present moment in time to historical network activity data previously collected. Detection of anomalous behavior enables a system to identify a malicious actor and execute a responsive action to prevent the malicious actor from causing harm to system.

### SUMMARY

The illustrative embodiments provide for compromised application detection propagation. An embodiment includes receiving an application tag identifying a workload received from a host-side application. The embodiment also includes sampling application workload data related to the application. The embodiment also includes comparing the workload data sampled to an expected workload pattern. The embodiment also includes detecting behavior corresponding to the application based on a result of comparing the workload data sampled to the expected workload pattern. The embodiment also includes issuing a security categorization for the application tag corresponding to the component of the application based at least in part on the behavior detected. The embodiment also includes propagating the security categorization issued for the application tag to a set of storage controllers. The embodiment also includes executing a responsive action based at least in part on the security categorization issued for application tag corresponding to the component of the application.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example network environment in accordance with an illustrative embodiment;

FIG. 3 depicts a block diagram of an example configuration of a community of storage controllers in accordance with an illustrative embodiment;

FIG. 4 depicts a block diagram of an example security assessment module in accordance with an illustrative embodiment;

FIG. 5 depicts a block diagram of an example process for compromised application detection propagation in accordance with an illustrative embodiment;

FIG. 6 depicts a flowchart an example process for compromised application detection propagation, in accordance with an illustrative embodiment;

FIG. 7 depicts a flowchart an example process for compromised application identification based on composite evidentiary data in accordance with an illustrative embodiment;

FIG. 8 depicts a flowchart of an example process for consensus based compromised application identification, in accordance with an illustrative embodiment; and

FIG. 9 depicts a flowchart of an example process for comprised application identification propagation, in accordance with an illustrative embodiment.

### DETAILED DESCRIPTION

According to an aspect of the invention, there is provided a computer-implemented method comprising receiving an application tag identifying a workload received from an application, sampling application workload data related to the application, comparing the workload data sampled to an expected workload pattern, detecting behavior corresponding to the application based on a result of comparing the workload data sampled to the expected workload pattern, issuing a security categorization for the application tag corresponding to the component of the application based at least in part on the behavior detected, propagating the security categorization issued for the application tag to a set of storage controllers, and executing by at least one storage controller a responsive action based at least in part on the security categorization issued for the application tag. A technical advantage of the computer-implemented method includes more improved network security as a result of more accurate threat detection.

In embodiments, the method further comprises issuing the security categorization for the application tag based on composite evidentiary data collected by a subset of the set of storage controllers. A technical benefit of detecting a security risk based on composite evidentiary data collected by multiple storage controllers includes enhanced accuracy and reliability in threat detection and mitigation. Combining evidentiary data from a subset of the set of storage controllers enables faster identification of threats, especially in situations where an individual storage controller may have collected insufficient evidentiary data to issue a security risk categorization alone.

In embodiments, the method further comprises updating the security categorization for the application tag based on a consensus between a subset of set of storage controllers. A technical benefit of updating the security categorization for the application tag based on a consensus between a subset of storage controllers includes reduction of noise caused by false-positives. Further, updating the security categorization for the application tag based on a consensus between a subset of set of storage controllers provides optimized resource allocation for execution of responsive actions. By accurately updating a security risk categorization based on consensus, resources can be allocated and prioritized based on a security risk.

In embodiments, the responsive action comprises at least one of a non-disruptive defensive action and a disruptive defensive action. A technical benefit of a non-disruptive defensive action includes maintaining of continuity of network operations without interruption. A technical benefit of a disruptive action includes prevention of damage to a network system caused by a bad actor.

In embodiments, the non-disruptive defensive action comprises a sending a notification to a host deploying the application, where the notification comprises details related to the security categorization issued for the application tag corresponding to the component of the application. A technical benefit of sending a notification to a host deploying the application corresponding to an application tag that has been issued a security categorization includes prevention of further exploitation of a potentially compromised application.

In embodiments, the non-disruptive defensive action comprises sending a notification to a security tool within a client’s environment, where the notification comprises details related to the security categorization issued for the application tag at application granularity. A technical benefit of sending a notification including details related to the security categorization issued for the application tag at application granularity includes enablement of further identification of identification potential application component vulnerabilities.

In embodiments, the non-disruptive defensive action comprises capturing a snapshot of volumes that are mapped to a host that the application tag is originating from. A technical benefit provided by capturing a snapshot of volumes that are mapped to a host that the application tag that has been issued to a particular security categorization originates from includes collection of forensic evidence that enables implementation of targeted remediation measures that require less computer resources to restore any affected systems to prior state rather in comparison to a broad restoration of the entire network of systems.

In embodiments, the non-disruptive defensive action comprises preventing new host volume mappings from a host that the application tag is originating from. A technical benefit provided by preventing new host mappings from a host that the application tag issued to a particular security categorization originates from includes protection of unaffected systems and data volumes from being compromised by a bad actor.

In embodiments, the non-disruptive defensive action comprises rejecting a write command from the application tag. A technical benefit provided by rejecting a write command from an application tag corresponding to a potentially compromised application includes mitigation of data corruption of data storage on a network storage.

In embodiments, the disruptive defensive action comprises taking volumes offline that are mapped to a host that the application tag is originating from. A technical benefit provided by taking volumes offline that are mapped to host deploying a potentially compromised application includes mitigation of data corruption of data stored on a network storage.

In embodiments, the disruptive defensive action comprises logging out a host deploying the application corresponding to the application tag each time a command is received from the application. A technical benefit provided by logging out a host deploying a potentially compromised application includes prevention of unauthorized data exfiltration of data stored on a network storage.

In embodiments, the disruptive defensive action comprises blocking access from the application to a network storage location. A technical benefit provided by blocking access of a potentially compromised application includes prevention of data corruption of data stored on a network storage.

According to an aspect of the invention, there is provided a computer program product comprising one or more computer readable storage media, and program instructions collectively stored on the one or more computer readable storage media, the program instructions executable by a processor to cause the processor to perform operations. The operations performed by execution of the program instructions by the processor include receiving an application tag identifying a workload received from an application, sampling application workload data related to the application, comparing the workload data sampled to an expected workload pattern, detecting behavior corresponding to the application based on a result of comparing the workload data sampled to the expected workload pattern, issuing a security categorization for the application tag corresponding to the application based at least in part on the behavior detected, propagating the security categorization issued for the application tag to a set of storage controllers, and executing by at least one storage controller a responsive action based at least in part on the security categorization issued for the application tag. A technical advantage of the computer program product includes more improved network security as a result of more accurate threat detection.

In embodiments, the stored program instructions are stored in a computer readable storage device in a data processing system, and the stored program instructions are transferred over a network from a remote data processing system. A technical benefit provided by this aspect includes enablement of remote deployment of the stored program instructions.

In embodiments, the stored program instructions are stored in a computer readable storage device in a server data processing system, and the stored program instructions are downloaded in response to a request over a network to a remote data processing system for use in a computer readable storage device associated with the remote data processing system, further comprising program instructions to meter use of the program instructions associated with the request, and program instructions to generate an invoice based on the metered use. A technical benefit provided by this aspect includes increased efficiency of computer resource utilization.

In embodiments, the security categorization for the application tag is based on composite evidentiary data collected by a subset of the set of storage controllers. A technical benefit of detecting a security risk based on composite evidentiary data collected by multiple storage controllers includes enhanced accuracy and reliability in threat detection and mitigation. Combining evidentiary data from a subset of the set of storage controllers enables faster identification of threats, especially in situations where an individual storage controller may have collected insufficient evidentiary data to issue a security risk categorization alone.

In embodiments, the stored program instructions further include program instructions to update the security categorization for the application tag based on a consensus between a subset of the set of storage controllers. A technical benefit of updating the security categorization for the application tag based on a consensus between a subset of storage controllers includes reduction of noise caused by false-positives. Further, updating the security categorization for the application tag based on a consensus between a subset of set of storage controllers provides optimized resource allocation for execution of responsive actions. By accurately updating a security risk categorization based on consensus, resources can be allocated and prioritized based on a security risk.

In embodiments, the responsive action comprises at least one of a non-disruptive defensive action and a disruptive defensive action. A technical benefit of a non-disruptive defensive action includes maintaining of continuity of network operations without interruption. A technical benefit of a disruptive action includes prevention of damage to a network system caused by a bad actor.

According to an aspect of the invention, there is provided a computer system comprising a processor and one or more computer readable storage media, and program instructions collectively stored on the one or more computer readable storage media, the program instructions executable by the processor to cause the processor to perform operations. The operations performed include receiving an application tag identifying a workload received from a host-side application, sampling application workload data related to the application, comparing the workload data sampled to an expected workload pattern, detecting behavior corresponding to the application based on a result of comparing the workload data sampled to the expected workload pattern, issuing a security categorization for the application tag corresponding to the component of the application based at least in part on the behavior detected, propagating the security categorization issued for the application tag to a set of storage controllers, and executing by at least one storage controller a responsive action based at least in part on the security categorization issued for the application tag. A technical advantage of the computer system includes more improved network security as a result of more accurate threat detection.

In embodiments, issuing the security categorization for the application tag based on composite evidentiary data collected by a subset of the set of storage controllers. A technical benefit of detecting a security risk based on composite evidentiary data collected by multiple storage controllers includes enhanced accuracy and reliability in threat detection and mitigation. Combining evidentiary data from a subset of the set of storage controllers enables faster identification of threats, especially in situations where an individual storage controller may have collected insufficient evidentiary data to issue a security risk categorization alone.

Application tagging enables optimization of data management and processing systems by facilitating the association of a unique identifier with input/output (I/O) operations. This unique identifier, which may specifically correspond to a particular application or application component, serves as a metadata marker that provides information about the source, purpose, and characteristics of the data being processed. By implementing application-specific tagging for I/O operations, an organization may achieve granular control over data, which enables improved monitoring, analysis, and resource allocation, among other advantages.

Accordingly, application tagging enables for a system’s I/O to be tagged with an application specific identifier, which further enables a storage or storage controller of a system to have insights of the application that sends commands to the storage. Existing techniques enable a specific OS, VM or application to tag workload with an application header. Existing techniques also that enable detection of a bad actor upon detection of a change in a host’s behaviour characteristics while performing certain actions, such as for example, behaviour characteristics while accessing storage. However, despite advancements in network monitoring practices, there is currently no existing technique or mechanism that enables association of bad actor detection with a slandering of the associated application tag, or a way of propagating an identity of a compromised entity between and/or related application tags to storage systems and/or storage controllers.

The present disclosure addresses the deficiencies described above by providing a process (as well as a system, method, machine-readable medium, etc.) that includes tagging applications with application specific tags, identifying an application that may be compromised, propagating the identity of the compromised application to various storage controllers, and executing one or more responsive actions upon identification of a compromised application via the one or more storage controllers of the various storage controllers of a network. The illustrative embodiments provide for compromised application detection propagation. A compromised application as referred to herein is an application that has been identified as associated with a security vulnerability or breach, or that has been potentially altered by a bad actor.

Embodiments disclosed herein describe propagating identification of a compromised application; however, use of this example is not intended to be limiting, but is instead used for descriptive purposes only. Instead, embodiments likewise cover propagation of identification of any compromised entity or component of a computer environment, including but not limited to, a virtual machine (“VM”), application container, operating system (“OS”), a user device, etc.

As used throughout the present disclosure, the term “storage controller” refers to an entity, device, or component that manages and controls access to storage resources within a network. A storage controller may facilitate the communication and data transfer between the storage devices within the network. Further, a storage controller may be responsible for organizing, directing, and optimizing data storage operations, and may execute tasks related to data retrieval, storage allocation, and data protection. A storage controller may be implemented in various forms, including but not limited to, a dedicated hardware device, or as a software program running on a server.

As used throughout the present disclosure, the term “bad actor” refers to a person or other entity that may act in a malicious manner towards a system. A bad actor may also be referred to as a threat or malicious actor, and includes any entity that may be partially or wholly responsible for an incident that impacts, or has the potential to impact, a system’s security. The actions of a bad actor may be accompanied by various motivations, including but not limited to, the intent to extort money, exfiltrate data, and/or disrupt operations of an organization. In the context of threat intelligence, actors are generally categorized as external, internal, or partner.

As used throughout the present disclosure, the term “application tag” refers to a unique identifier corresponding to a specific application or application component. Although the term “application tag” is used throughout, it is contemplated herein that the application tag may also include VM specific identifier, a container specific identifier, etc. Accordingly, an application tag identifies an application or application component from which an operation originates. Further, an application tag may include a recurring application-identifier that is associated with all of the workload originating from that application. In some embodiments, as a result of an application tagging technique, a storage or storage controller may obtain knowledge of the applications, VMs, containers, etc. sending commands to the storage or storage controller.

As used throughout the present disclosure, the term “consensus” refers to an agreement between multiple entities that an application comprises a compromised application. Further, a consensus may likewise include an agreement between multiple entities of the security classification for an application tag or an application that corresponds to the same application tag.

As used throughout the present disclosure, the term “evidentiary data” refers to any data collected that may be indicative that an application may be compromised. In the context of I/O operations, evidentiary data may include, but is not limited to, unusual access patterns, unexpected data exfiltration, anomalous user account activity, unusual system resource usage, unexpected modification of a system configuration, unusual network traffic, abnormal file access patterns, unauthenticated requests or transactions, unexpected system calls, and inconsistent geographical access.

As used throughout the present disclosure, the term “composite evidentiary data” refers to an aggregate of evidentiary data that collectively may be indicative that an application may be compromised. For example, there may be a scenario where some evidentiary data collected is insufficient for a determination that an application is compromised. However, evidentiary data may be collected by multiple entities, and the evidentiary data may be synchronized and/or aggregated to form composite evidentiary data, such that the composite evidentiary data enables a determination of whether an application is compromised.

As used throughout the present disclosure, the term "workflow data" refers to information generated or used during the execution of a specific process or workflow within a system or organization. Examples of workflow data may include, but are not limited to, sequence of tasks, the individuals or systems responsible for each task, timestamps indicating when tasks are started and completed, and/or any intermediate or final outcomes produced by the workflow. As used throughout the present disclosure, the term “workload data” refers to information related to the volume and distribution of tasks or activities within a given system or organization, typically over a defined period. Examples of workload data may include, but are not limited to, the number of tasks processed, time taken to complete each task, resource utilization, and any patterns in workload levels over time. In some embodiments, evidentiary data may include any types of workflow and/or workload data. Further, in any instances where workflow data is specifically mentioned, it is contemplated that workload data may be substituted by and/or supplemented by workload data, and vice versa.

Illustrative embodiments include monitoring application activity to detect anomalous behavior based on data collected during monitoring application activity. Illustrative embodiments include collecting evidentiary data related to suspicious I/O operations performed via one or more applications. Illustrative embodiments further include synchronizing and/or aggregating evidentiary data collected by multiple separate entities across a network.

Illustrative embodiments include issuing a security risk categorization for an application tag defining a security risk corresponding to a specific application or application component. In some embodiments, one or more existing application tagging techniques are utilized to provide application tags for an application or application components of an application. In an embodiment, the security risk categorizations that may be issued for and associated with specific application tags that define a security risk may include, but are not limited to, characterizations such as “Compliant”, “Suspected”, “Compromised”, “At-risk”, etc.

Illustrative embodiments include propagating a security risk categorization or classification of an application or application component associated with a specific application tag to one or more storage controllers of a network. In some embodiments, a host-generated application tag, and a controller-generated security classification, is propagated to one or more storage controllers. Illustrative embodiments further initiating a consensus-based determination of the security characterization of an application or application component, based an agreement between multiple storage controllers regarding the characterization of the application or application component. Further, a consensus may likewise include an agreement between multiple entities of the security classification for an application that corresponds to the same application tag.

Illustrative embodiments include automatically executing a responsive action upon identification of a compromised application. In some embodiments, the responsive action includes a non-disruptive defensive action. In some embodiments, the responsive action includes a disruptive defensive action. A non-disruptive action may include an action that does not broadly affect I/O access. A non-disruptive action may include, but is not limited to, notifying the security tools within a client’s environment, such as for example, an SEIM (security event and incident management software), at application granularity. Another example non-disruptive action may include notifying the host deploying the application that the application tag is suspicious, so that the host may execute one or more actions to rectify the detected suspicious activity that does not result in disruption of other applications running on the host. Another non-disruptive action may include, but is not limited to, taking a snapshot of volumes that are mapped to the host that the application tag is originating from. Another non-disruptive action may include, but is not limited to, preventing new host volume mappings from a host that the application tag is originating from. Another non-disruptive action may include, but is not limited to, rejecting write commands from the application tag.

A disruptive action may include an action that does affect I/O access. A disruptive action may include, but is not limited to, rejecting a command received from the application tag without impacting other applications running on the host. Another example disruptive action may include, but is not limited to, taking volumes offline that are mapped to the host that the application tag is originating from. Another example disruptive action may include, but is not limited to, logging out the host running the application, and if the host logs back in, then upon receiving a command from the application, logging out the host again. In such scenario, user intervention may be required to in order to re-allow sending commands from the application without causing the host to be logged out upon receiving a command from the application.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

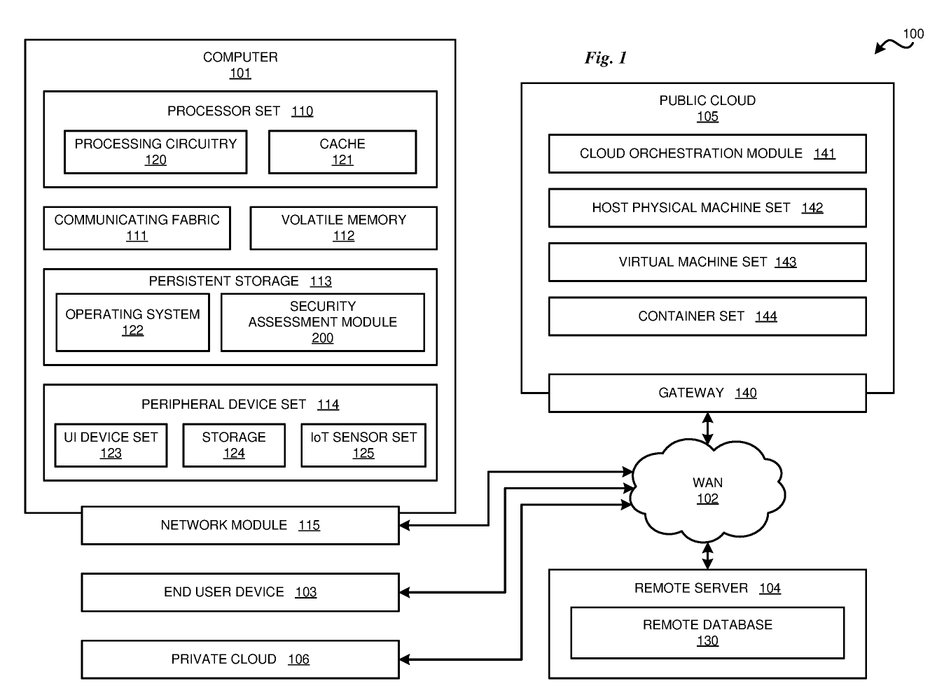

With reference to FIG. 1, this figure depicts a block diagram of a computing environment 100. Computing environment 100 contains an example of an environment for the execution of at least some of the computer code involved in performing the inventive methods, such as security assessment module 200 that monitors application activity to detect a compromised application and propagates the identity of the compromised application to other storage controllers of the network. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

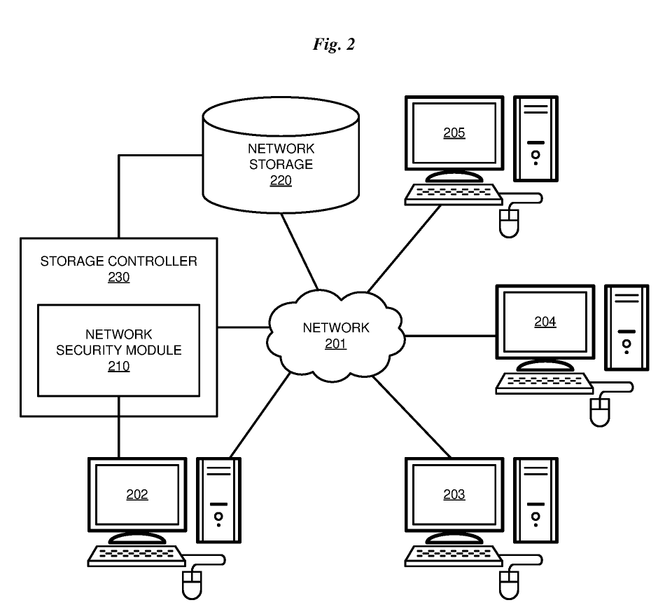

With reference to FIG. 2, this figure depicts a block diagram of an example network environment. In the illustrated embodiment, the network security module 210 includes the security assessment module 200 of FIG. 1.

In the illustrated embodiment, the network environment depicts a plurality of client devices connected via network 201. In the illustrated embodiment, the network 201 may include any suitable network. In the illustrated embodiment, the plurality of client devices includes a first client device 203, a second client device 204, and a third client device 205. In the illustrated embodiment, each of client device may be running one or more software applications that causes data to be transmitted to and/or retrieved from network storage 220. Although only a single network storage 220 is shown for the sake of simplicity, it is contemplated herein that the network environment may include any number of storage locations connected via network 201. A client device may include any computing device, including but not limited to, a computer, laptop, smartphone, or any device that interacts with the network. Each client device runs software applications that generate, process, or consume data. The software applications include programs and/or processes that run on the client devices, designed to perform specific tasks, that include generating, manipulating, and/or sending requests that data that may need to be stored or retrieved.

Further, the network environment may include one or more storage controllers, such as storage controller 230, that are responsible for managing and controlling access to storage resources within the network, such as network storage 220. Accordingly, the storage controller 230 may facilitate communication between the client device and/or software application and the network storage 220. The client device provides access to a software application that may generate, process, or consume data. The software application interacts with the storage controller 230 to store or retrieve data. The software application communicates with the storage controller 230 to initiate storage or retrieval operations. The storage controller 230 manages these requests and facilitates the actual data transfer to or from the storage location. The storage controller 230 communicates with the storage location to execute the data storage or retrieval operation. The client device indirectly interacts with the storage location through the software application and the storage controller. The storage controller ensures that data is efficiently and securely transferred between the client device and the storage location.

In the illustrated embodiment, the network security module 210 is a software application configured to monitor activities across the network environment and detect a compromised application connected via network 201. Further, the network security module 210 is configured to identify a compromised application, and propagate the identity of the compromised application to one or more storage controllers. In an embodiment, the network security module 210 is configured to perform an application tagging technique, such that the network security module 210 may assign one or more application tags to an application or application component. In another embodiment, the network security module 210 is configured to receive one or more application tags from a host device that has generated the application tag. Further, in an embodiment, network security module 210 is configured to issue a security characterization for one or more application tags based on the behavior related to the application or application component. An example of a security classification issued for an application tag may include, but is not limited to, “Compliant”, “Suspected”, “Compromised”, at “Risk”, etc., which are described in greater detail herein. In the illustrated embodiment, network security module 210 is integrated into storage controller 230, thereby enabling storage controller 230 to assess the behavior and/or security of an application attempting to connect to and communicate with network storage 220. In some other embodiments not depicted, network security module 210 may be a standalone software application and/or integrated with a different software application and/or hardware device, and may be configured to perform operations described herein and transmit results of said operations to one or more storage controllers.

In an embodiment, security risk categorisation may be performed in parallel across multiple systems within the community. One advantage of performing security risk categorization in parallel includes enabling faster categorisation in comparison to risk categorization performed on an individual system. Another advantage of performing security risk categorization in parallel includes the ability to perform a categorization that may be otherwise not be possible by an individual system, such as in a scenario where an individual system has insufficient evidentiary data to make a determination of a security risk categorization. Accordingly, a community of storage controllers may possess a collective understanding of the categorisation for an application tag across community members. In an embodiment, the determination of a particular categorization of an application is at least in part based on a result of a predetermined percentage of members in consensus with each other. In another embodiment, the determination of a particular categorization of an application is based at least in part on meeting a predetermined threshold number of members in consensus with each other. In some embodiment, consensus between community members may enable promotion and/or demotion of a particular security characterization issued for an application tag associated with an application. For example, suppose a scenario where a threshold number and/or percentage of storage controllers determines a “Suspected” security characterization for an application tag for a particular application, then the application tag for that particular application may be promoted to “Compromised” and the updated characterization of the application tag may be propagated to each storage controller within the community.

In the illustrated embodiment, the administrator device 202 is shown connected to the network security module 210. In the illustrated embodiment, the administrator device 202 include a computing device configured to enable a user having sufficient privileges to perform various administrative tasks related to network security module 210. An example administrative task may include, but is not limited to, setting various parameters, settings, initiating an application monitoring and/or network monitoring process, etc. In some embodiments, the administrative device 202 allows an administrative user to set a threshold consensus percentage that defines a percentage of storage controllers of a community of storage controllers in agreement with each other, such that upon exceeding the threshold consensus percentage, a security risk categorization or classification for an application tag is determined, promoted, or demoted. In some embodiments, the administrative device 202 allows an administrative user to set a threshold consensus number that defines a number of storage controllers of a community of storage controllers in agreement with each other, such that upon exceeding the threshold consensus number, a security risk categorization or classification for an application tag is determined, promoted, or demoted. In some embodiments, the administrator device 202 allows an administrative user to define security risk categorizations or classifications for application tags. In some embodiments, the administrator device 202 allows an administrative user to configure automatic responsive actions to execute upon a determination that an application is compromised, suspected of being compromised, etc., as described in greater detail herein.

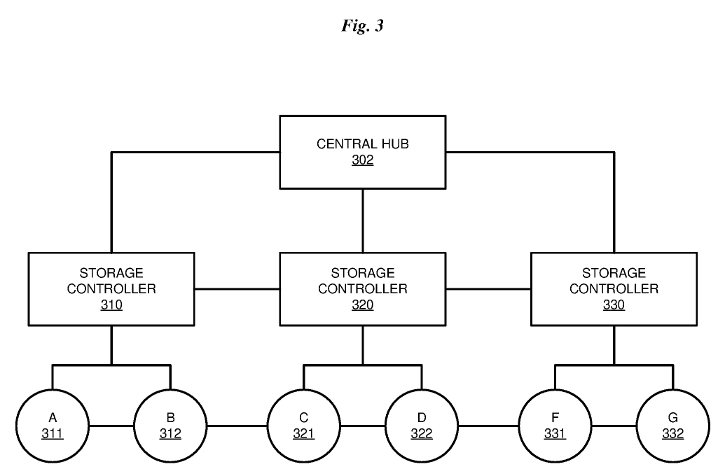

With reference to FIG. 3, this figure depicts a block diagram of an example configuration of a community of storage controllers. In the illustrated embodiment, the central hub 302 represents a central data storage of a network. Although for the sake of simplicity only a single central hub 302 is shown, it is contemplated that a network may comprise any number of data storage locations, and embodiments disclosed herein are not limited to a network comprising a single central hub 302. In the illustrated embodiment, a community of storage controllers interfacing with central hub 302 are shown, including a first storage controller 310, a second storage controller 320, and a third storage controller 330. In the illustrated embodiment, a plurality of nodes is shown interacting with the community of storage controllers, including Node A 311 and Node B 312 interfacing with the first storage controller 310, Node C 321 and Node D 322 interfacing with the second storage controller 430, and Node F 331 and Node G 332 interfacing with the third storage controller 330.

In the illustrated embodiment, each node may represent a particular application, device, component, and/or user of a network. In some embodiments, each node may represent a user interacting with a particular application that is mediated via a respective storage controller for accessing central hub 302, to perform certain actions related to retrieving and/or storing data on central hub 302. In the illustrated embodiment, each storage controller of the community of storage controllers may be integrated with a network security module and/or security assessment module, as described in greater detail herein. In an embodiment, the originator of a workload (e.g. host) has already labelled that workload with the application tag. The storage controller can assess whether that workload is indicative of a bad actor, and associate a security risk categorization with that externally provided application tag. Storage controllers then share these security risk characterizations for application tags and related data with other storage controllers.

In some such embodiments, the storage controller integrated with a network security module and/or a security assessment module configured to detect anomalous behavior corresponding to an application, issue a security risk categorization for an application tag based in part on the anomalous behavior detected, and propagate the security risk categorization for an application tag and related data to other storage controllers of the community of storage controllers. For example, suppose the first storage controller 310 detects anomalous behavior associated with an application represented by Node A 311, and upon detection of anomalous behavior of Node A 311, storage controller 310 issues a “Compromised” security risk classification for the application tag defining Node A 311. Further, suppose that Node C 321 represents the same application as Node A 311. In such a scenario, the first storage controller 310 may propagate its “Compromised” security risk classification for the application tag to the second storage controller 320 so that second storage controller 320 may execute an appropriate responsive action in a similar manner that the first storage controller 310 may execute an appropriate responsive action upon determination of a compromised application.

Suppose another scenario where each node of the group of nodes including Node A 311, Node B 312, Node C 321, Node D 322, Node F 331, and Node G 332 all represent the same application being accessed by different respective users. Further, suppose in such a scenario that the first storage controller 310 collects evidentiary data indicative that the application might be compromised, but such evidentiary data is insufficient to make a determination of any particular risk categorization. Further, suppose that second storage controller 320 collects evidentiary data indicative that the application might be compromised, but such evidentiary data is insufficient to make a determination of any particular security risk categorization. Further, suppose that the third storage controller 330 collects evidentiary data indicative that the application might be compromised, but such evidentiary data is insufficient to make a determination of any particular security risk categorization. In such a depicted scenario, embodiments disclosed herein include synchronizing and/or aggregating the evidentiary data collected by each storage controller, which may enable a determination of a security risk characterization to issue for and associate with an application tag corresponding to the application based on composite evidentiary data formed from a combination of all the individual evidentiary data collected by each storage controller.

Suppose another scenario where Node A 311, Node C 321, and Node F 331 each correspond to the same application. Further, suppose that the first storage controller 310 issues a “Suspected” security risk classification for an application tag corresponding to Node A 311, the second storage controller 320 issues a “Suspected” security risk classification for an application tag corresponding to Node C 321, and the third storage controller 330 issues a “Compliant” security risk classification for an application tag corresponding to Node F. Further, suppose that a consensus threshold is defined as either 2 or more storage controllers in agreement with each other, or the consensus threshold is defined as 2/3 of storage controllers are in agreement with each other. In such a scenario, embodiments disclosed herein may include promoting the security risk classification for application tag of Node A 311 from “Suspected” to “Compromised”, promoting the security risk classification for application tag of Node C 321 from “Suspected” to “Compromised”, and promoting the security risk classification for application tag of Node F 331 from “Compliant” to “Compromised”. The example scenarios depicted are intended to illustrate the ability of individual storage controllers to communicate with each other, and determine particular actions collectively based on aggregate data shared between each other. The specific configuration of decision-making, thresholds, and other settings may be implementation specific, and may be based at least in part on the manner in which the network security module and/or security assessment module is configured, as discussed herein.

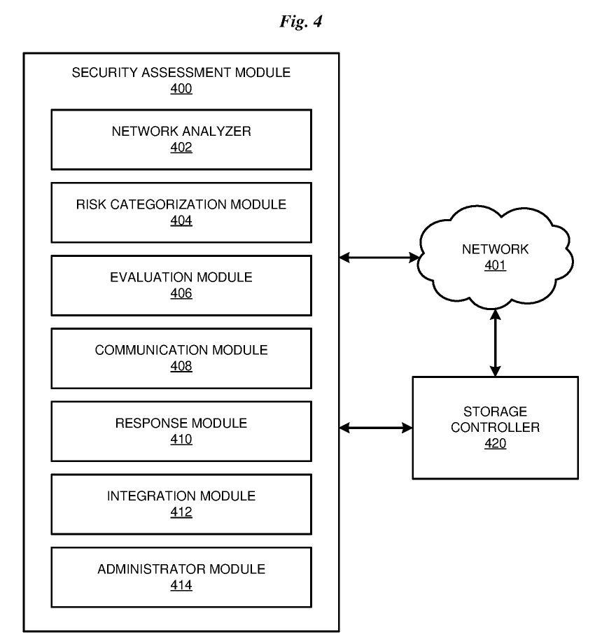

With reference to FIG. 4, this figure depicts an example security assessment module, in accordance with an illustrative embodiment. In the illustrated embodiment, the security assessment module 400 may include security assessment module 200 of FIG. 1, and/or network security module 210 of FIG. 2. In the illustrated embodiment, network 401 may include network 201 of FIG. 2. In the illustrated embodiment, storage controller 420 may include any storage controller of FIG. 3.

In the illustrated embodiment, security assessment module 400 is a software module that includes a plurality of software modules. In the illustrated embodiment, the security assessment module 400 includes a network analyzer module 402, a risk categorization module 404, an evaluation module 406, a communication module 408, a response module 410, an integration module 412, and an administrator module 414. In alternative embodiments, the security assessment module 400 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the network analyzer module 402 is a software module configured to analyze and collect network data related to one or more applications across network 401 from network 401. In the illustrated embodiment, the network data includes application data, including application data related to data storage and retrieval to and from a storage location of network 401. In an embodiment, the application data may include workflow data and/or workload data. In the illustrated embodiment, the network analyzer module 402 is configured to collect evidentiary data indicative of a potentially compromised application. In an illustrative embodiment, the network analyzer module 402 is configured to detect one or more indicators of compromise (IoC) based on the network data collected, including, for example, evidentiary data.

In the illustrated embodiment, security assessment module 400 may receive an application tag from a host device deploying an application corresponding to the application tag. In an embodiment, the application tag is host-generated. In some other embodiments, the application tag may be controller-generated. Application tagging performed by a host or by the controller may include associating specific labels or tags with different components, tasks, or processes within an application or system. Accordingly, these tags may enable categorization and identification of various elements of a workflow, and thereby enabling monitoring, analysis, and management of a system. Each component, module, or service involved in a workflow may be assigned a unique tag. Further, tags enable granular tracking of specific actions or events within the workflow. Accordingly, tagging individual tasks or processes enables detailed insights into the performance and behavior of each component and/or process of an application.

Further, the risk categorization module 404 may be configured to assign a security categorization to an application tag corresponding to an application based on an indication and/or likelihood that an application has been compromised. Application tagging of commands enables the storage controller 420 to continuously monitor behaviour of applications at a finer granularity than a “host” or “port”. Examples of well-known mechanisms for monitoring and bad actor detection can include sampling current workload characteristics and comparing the current workload characteristics to typical historically observed workload characteristics, compressibility of data written, ownership of data, and various other mechanisms known by those skilled in the art. Accordingly, if the network analyzer module 402 collects data of behaviour that indicates that an originator of some data is a security risk, a novel security risk categorisation may be applied to the associated application tag.

In an embodiment, an example security risk categorization scheme may include the following classifications: “Compliant”, “Suspected”, “Compromised”, and “At Risk”. Accordingly, a “Compliant” classification may indicate that there is no reason to suspect security concerns as a result of monitoring/sampling. A “Suspected” classification may indicate that there is a suspected security concerns as a result of monitoring/sampling. “Suspected” application tags can be targeted for additional monitoring and sampling locally and on other members of the community. Some defensive actions can be taken to limit the damage should the suspected application become compromised. A “Compromised” classification may indicate that (either by community verdict or local monitoring/sampling) an application tag has been identified to be associated with a bad actor. Additional and/or more drastic defensive responsive actions may be taken to limit the impact of the compromised application. Further, the identity of the compromised application may be propagated to other members of the community so that other storage controllers may also take immediate defensive actions. An “At Risk” tag may indicate a related, but different application tag that shares characteristics with another application tag that has been previously identified as compromised. Further, an “At Risk” classification may be used to prioritise additional monitoring/sampling of a tagged application to determine if the application is “Compliant”, “Suspected” or “Compromised”, or to perform some earlier non-disruptive defensive action. For example, if multiple application tags representing the same recently upgraded OS level have been recently categorised as “Compromised”, the remaining application tags associated with that same level of OS could be immediately classified as “At risk” to receive increased analysis or protection.

In the illustrated embodiment, the communication module 408 is a software module configured to communicate evidentiary data and/or information regarding application tag categorizations to one or more storage controllers of a community of storage controllers of the network 401. For example, in an embodiment, when a community storage controller member updates the storage controller’s own classification of an application tag, the storage controller may broadcast this update to other member storage controllers of the same community. In response, those members of the community may then immediately update their own classifications of that application tag without observing additional behaviour of the activity associated with that application tag. Further, at risk application tags may also be identified based on similarity to “Compromised” or “Suspected” application tags.

In the illustrated embodiment, the evaluation module 406 is a software module configured to evaluate a security tag classification based at least in part on evidentiary data collected by network analyser module 402. In an embodiment, the evaluation module 406 may evaluate a security tag classification based at least in part on evidentiary data collected from multiple separate members of a community, such that the evaluation module 406 evaluates a security tag classification based at least in part on aggregate evidentiary data formed from a composite of evidentiary data collected from each member. In an embodiment, security risk categorisation may be performed in parallel across multiple systems within the community. It is contemplated herein that parallel security risk categorization allows both faster categorisation, as well as categorisations that no individual system might reach individually. Accordingly, the community as a whole may provide an understanding of the categorisation for an application tag across community members. For example, given that an appropriate percentage or number of members where the application tag is present have determined that the application tag to be “Suspect” then the community may decide to promote the application tag to “Compromised”. Further, if a set of related application tags (e.g. multiple tags identifying the same specific application or OS version) are identified as compromised in a predetermined sufficiently short sampling interval, the evaluation module 406 may proactively promote any remaining related application tags to “Suspected.”

In the illustrated embodiment, the response module 410 is a software module configured to acuate a response action upon identification of an anomaly. In some embodiments, an example response action that may be actuated may include, but is not limited to, generating an alert to notify an interested party regarding the unusual activity, notifying end-users, device owners, or hosts about the detection of anomalous behavior, isolating one or more suspicious applications or devices from the network, implementing network segmentation to isolate and contain the impact of the anomalous application, implementing a temporary network lockdown to restrict communication, adjusting firewall rules to block or restrict traffic from the suspicious application based on the detected anomalies, updating authentication protocols and/or access control policies to prevent unauthorized access, and various other response actions as described in greater detail herein.

In the illustrated embodiment, the integration module 412 is a software module configured to enable the security assessment module 400 to integrate with a network, a computing device, a software application, and/or various other components. In an embodiment, the integration module 412 is configured to integrate the security assessment module 400 with a network 401 to enable the security assessment module 400 to analyze and collect data from the network 401. In an embodiment, the integration module 412 is configured to integrate the security assessment module 400 into a storage controller 420 to monitor I/O related operations, requests, and/or commands originating from various application over a network, as described in greater detail herein. In an embodiment, the integration module 412 is configured to integrate with a computing device connected to a network to analyze and collect data related to the device. In an embodiment, the integration module 412 is configured to integrate with security information and event management (SIEM) software.

In the illustrated embodiment, the administrator module 414 is a software module configured to enable a user having sufficient privileges to perform various administrative actions associated with security assessment module 400. An example administrative action may include, but is not limited to, setting various parameters, settings, imitating a network monitoring process, etc. In some embodiments, the administrator module 414 allows an administrative user to set a threshold consensus, such that upon exceeding the threshold consensus, a security risk characterization for an application tag is issued, promoted, or demoted. In some embodiments, the administrator module 414 allows an administrative user to configure one or more automatic response actions that may be executed upon identification of a compromised application, as described in greater detail herein.

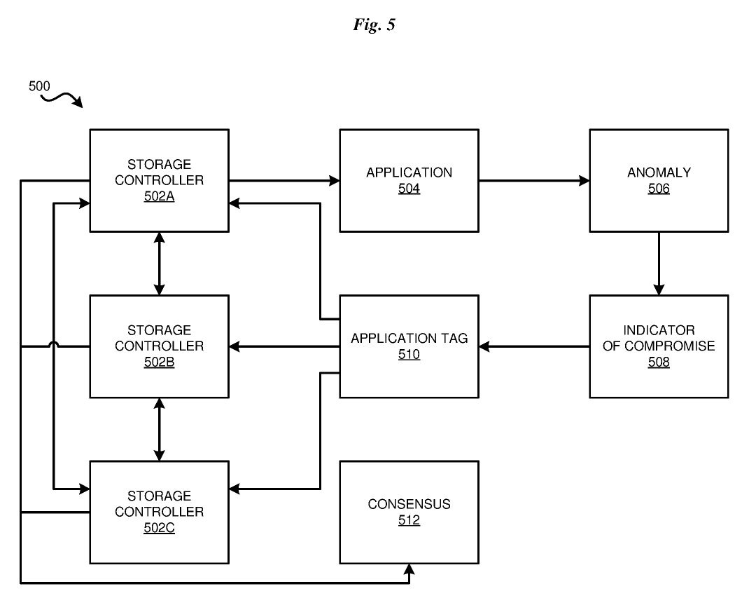

With reference to FIG. 5, this figure depicts a block diagram of an example process for compromised application detection propagation, in accordance with an illustrative embodiment. In the illustrated embodiment, the process 500 is depicted as being performed in accordance with a community of storage controllers, including a first storage controller 502A, a second storage controller 502B, and a third storage controller 502C. In the illustrated embodiment, each storage controller is configured to perform process 500.

In the illustrated embodiment, the first storage controller 502A monitors application 504 to detect an anomaly 506 related to the behavior of application 504. Further, upon detection of anomalous behavior, the process 500 may identify an indicator of compromise 508 related to the anomaly detected. Further, depending on the indicator(s) of compromise identified, the process 500 may classify an application tag 510 with a particular security risk categorization. In an embodiment, the application tag 510 may be classified as, for example, “Compliant”, “Suspected”, “Compromised”, “At-risk”, etc. Further, upon issuance of a particular security risk classification for the application tag 510, the process may propagate the application tag 510 as well as the security risk classification now associated with the application tag 510 to each member of the community, including the first storage controller 502A, the second storage controller 502B, and the third storage controller 502C. In an embodiment, a host issues the application tag 510, and a controller associates a security classification with the application tag 510 and propagates both the application tag 510 and the security classification to the community. In the illustrated embodiment, the application tag 510 may represent the data communicated to other controllers in the community, and may include the specific application tag corresponding to application 504 which identifies the application 504, as well as the security classification. In an embodiment, the application tag and the security classification are separate data items. In some other embodiments, the security classification is integrated into the application tag.

Although in the illustrated embodiment, only the first storage controller 502A is shown performing the steps of process 500, it is contemplated herein that the second storage controller 502B, and the third storage controller 502C may likewise be performing steps of process 500 at the same time, and likewise may be propagating application tags related to applications and security classifications associated to said application tags to each other. Further, the illustrated embodiment depicts propagation of application tags between storage controllers, however, this is not intending to be limiting; instead, each storage controller may send any type of data between each other, including evidentiary data, data related to anomalous behavior, data related to an indicator of compromise, etc. Further, issuance of the security classification associated with application tag 510 may be determined based on aggregate data comprising of the collective data shared between storage controllers, as described in greater detail herein.

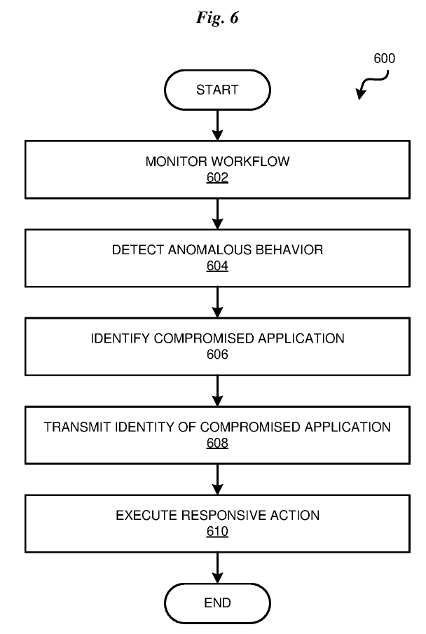

With reference to FIG. 6, this figure depicts a flowchart an example process for compromised application detection propagation, in accordance with an illustrative embodiment. In some embodiments, security assessment module 200 of FIG. 1, network security module 210 of FIG. 2, and/or security assessment module 400 of FIG. 4 carries out process 600.

In the illustrated embodiment, at step 602 the process monitors workflow of an application. At step 604, the process detects anomalous behavior based on the data collected resultant from monitoring the workflow of the application. At step 606, the process identifies a compromised application based on the anomalous behavior detected. In an embodiment, identifying a compromised application further includes issuing a security categorization to an application tag associated with the application. For example, the security categorization may include, but is not limited to, “Compliant”, “Suspected”, “Compromised”, or “At-risk”.

At step 608, the process transmits the identity of the compromised application to one or members of a community. In an embodiment, the process transmits an application tag of the application as well as a security classification associated with the application tag denoting a security categorization to one or more storage controllers of a network. In an embodiment, the process propagates the security tag categorization to every storage controller of a community of storage controllers of a network. In an embodiment, step 608 includes transmitting a host generated application tag and a controller generated security risk classification to a subset of storage controllers of the community of storage controllers.

At step 610, the process executes a responsive action upon identification of a compromised application. In an embodiment, the process executes at least one of a non-disruptive action, or a disruptive action. In an embodiment, a non-disruptive response action may include any action that does not broadly affect I/O access, which may include, but is not limited to, notifying a security tool within the client’s environment, such as an SEIM (security event and incident management software) at application granularity, notifying the host of the application that the application tag is suspicious and/or indicates potential compromise, or any other action to rectify potential compromise that that does not result in disruption of other applications running on the host. A non-disruptive defensive response action may further include automatically capturing a snapshot of volumes that are mapped to the host that the application tag is originating from, preventing new host volume mappings from a host that the application tag is originating from, and/or rejecting any write commands from the application tag.

In an embodiment, the responsive action may include various other responsive actions. For example, the responsive action may also include, but is not limited to, generating an alert to notify an interested party regarding the unusual activity. In some embodiments, the alert may include a text communication, such as for example, a text message, an email, or any other text-based communication. In an embodiment, the process includes triggering an automated incident response workflow to coordinate various security processes, such as alerting, investigation, and remediation. In an embodiment, the process includes integrating with security information and event management (SIEM) solutions to correlate anomalous network device behavior with other security events and gain a holistic view of potential threats. In an embodiment, the process includes notifying end-users or device owners about the detection of anomalous behavior, instructing them on security best practices or actions to take.

In an embodiment, the process includes isolating one or more suspicious applications from the network to prevent further communication and potential spread of threats. In an embodiment, the process includes implementing network segmentation to isolate and contain the impact of the suspicious application. In an embodiment, the process includes prioritizing and deploying necessary patches or updates to address vulnerabilities that may have been exploited by the compromised application. In an embodiment, the process includes implementing a temporary network lockdown to restrict all non-essential communication while a security team investigates the incident. In an embodiment, the process includes adjusting firewall rules to block or restrict traffic from the suspicious application based on the detected anomalies. In an embodiment, the process includes updating authentication protocols and/or access control policies to prevent unauthorized access.

In an embodiment, the process includes analyzing the network traffic patterns and behavior of the applications to determine the patterns/behavior exhibit characteristics of malicious activity. In an embodiment, the process includes performing a deep packet inspection on the network traffic associated with the application to identify malicious patterns or activities. In an embodiment, the process includes inspecting and blocking malicious traffic, preventing potential attacks from reaching selected components and/or systems of the network.

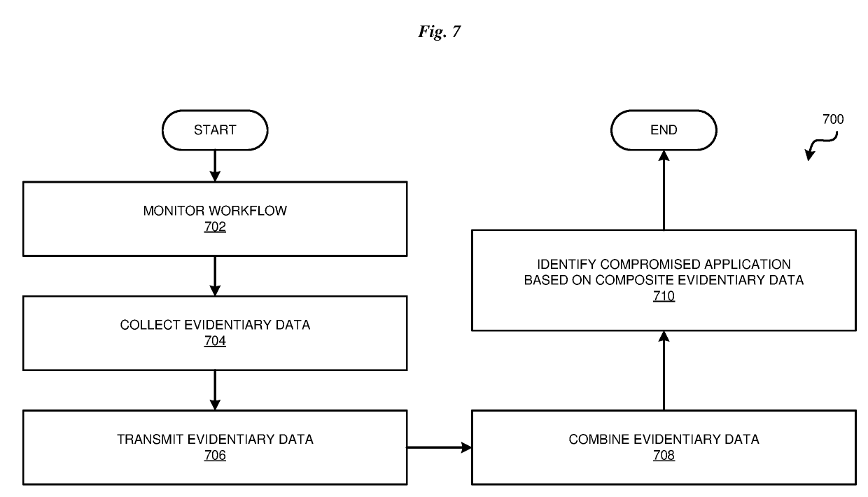

With reference to FIG. 7, this figure depicts a flowchart an example process for compromised application identification based on composite evidentiary data. In some embodiments, security assessment module 200 of FIG. 1, network security module 210 of FIG. 2, and/or security assessment module 400 of FIG. 4 carries out process 700.

In the illustrated embodiment, at step 702, the process monitors the workflow of an application. In an embodiment, monitoring the workflow of an application may include, but is not limited to, monitoring the I/O related operations performed via the application. At step 704, the process collects evidentiary data that is indicative of a potentially compromised application. In an embodiment, the evidentiary data includes one or more indicators of compromise that may indicate that an application or component of an application has been compromised by a bad actor.

At step 706, the process transmits the evidentiary data from a local collection location to a collective data location. At step 708, the process combines the evidentiary data from one or more local collection locations to form a composite evidentiary data. In an embodiment, combining the evidentiary may include synchronizing and/or aggregating evidentiary data received from a plurality of individual storage controllers. At step 710, the process identifies a compromised application or application component based on the composite evidentiary data. Additional steps of process 700 may include, but are not limited to, propagating the identity of the compromised application or application component to all members of a community, automatically initiating a responsive action, issuing and/or modifying a security categorization for an application tag, etc.

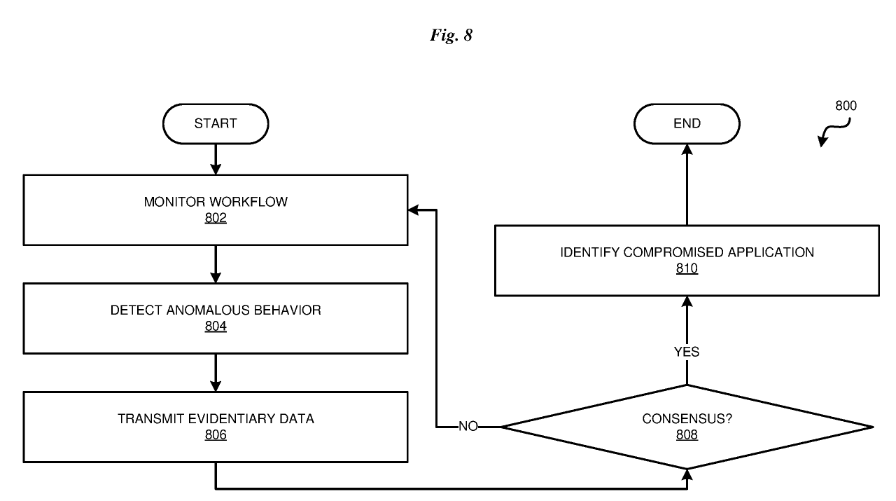

With reference to FIG. 8, this figure depicts a flowchart of an example process for consensus based compromised application identification, in accordance with an illustrative embodiment. In some embodiments, security assessment module 200 of FIG. 1, network security module 210 of FIG. 2, and/or security assessment module 400 of FIG. 4 carries out process 800.

In the illustrated embodiment, at step 802 the process monitors the workflow of an application. In an embodiment, monitoring the workflow of an application may include any combination of existing techniques for monitoring the workflow and/or workload of an application. In an embodiment, monitoring the workflow of an application includes monitoring the input and output (I/O) related functions of an application. At step 804, the process detects anomalous behavior based on evidentiary data collected during monitoring the workflow of the application. In an embodiment, the process further issues an application tag security categorization based on the anomalous behavior detected. At step 806, the process transmits the evidentiary data to another storage controller. In an embodiment, the process further transmits the identity of an application tag security categorization to another storage controller.

At step 806, the process determines whether there is a consensus amongst a plurality of storage controllers regarding an application tag security categorization. Accordingly, steps of process 800 may be individually and collectively performed by multiple storage controllers. In such a scenario, each storage controller may or may not identify a compromised application or application component on its own. Further, at step 808 the individual determinations between individual storage controllers may be compared to collectively determine whether there is a consensus amongst storage controllers regarding the identification of a compromised application or application component. If there is no consensus (i.e., a consensus threshold is not met), then there is no collective update to the identity of a potentially compromised application or application component. Otherwise, if a consensus is reached, then at step 810 the process identifies a compromised application or application component based on the consensus reached between storage controllers of the same community. Additional steps of process 800 may include, but are not limited to, propagating the identity of the compromised application or application component to all members of a community, automatically initiating a responsive action, issuing and/or modifying a security categorization for an application tag, etc.

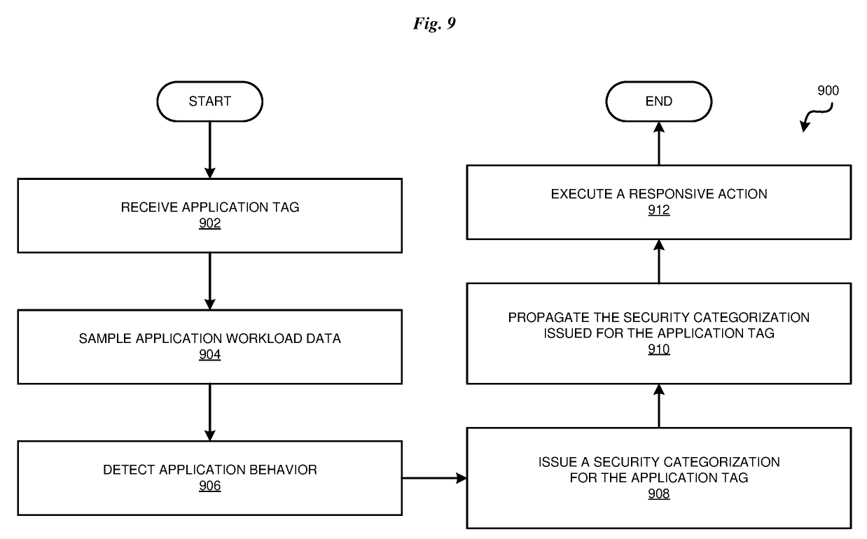

With reference to FIG. 9, this figure depicts a flowchart an example process for compromised application detection propagation, in accordance with an illustrative embodiment. In some embodiments, security assessment module 200 of FIG. 1, network security module 210 of FIG. 2, and/or security assessment module 400 of FIG. 4 carries out process 900.

At step 902, the process receives an application tag corresponding to an application or component of an application. In an embodiment, the process may include executing an application tagging process to associate an application or application component with a specific tag based identifier. In some other embodiments, the application tag(s) are provided by an external tagging mechanism.

At step 904, the process samples application workload data corresponding to the application. In an embodiment, the process further includes comparing the workload data sampled to an expected workload pattern. In some embodiments, the expected workload pattern is based at least in part on historically observed workload data. In some other embodiments, the expected workload pattern is based at least in part on expected behavior characteristics retrieved from an external data source.

At step 906, the process detects behavior corresponding to the application based on a result of comparing the workload data sampled to the expected workload pattern. In some embodiments, detecting the behavior corresponding to the application may include detecting anomalous behavior based on a comparison between the workload data sampled and the expected workload pattern. In some embodiments, detecting the behavior corresponding to the application may include detecting non-anomalous, expected, routine behavior, based on the comparison between the workload data sampled and the expected workload pattern.

At step 908, the process issues a security risk categorization for the application tag corresponding to the component of the application based at least in part on the behavior detected. For example, suppose the behavior detected is anomalous, in which case the security risk characterization issued may be “Suspected” or “Compromised”. As another example, suppose the behavior detected is non-anomalous, in which case the security risk characterization may be “Compliant”.

At step 910, the process propagates the security risk categorization issued for the application tag to a set of storage controllers across a network. At step 912, the process executes responsive action by at least one storage controller based at least in part on the security risk categorization issued for the application tag. It is contemplated herein that steps of process 600, 700, 800, and/or 900 may be combined and/or omitted to arrive at a process that is within the scope of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ± 8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
receiving an application tag identifying a workload received from an application;
sampling application workload data related to the application;
comparing the workload data sampled to an expected workload pattern;
detecting behavior corresponding to the application based on a result of comparing the workload data sampled to the expected workload pattern;
issuing a security categorization for the application tag corresponding to the component of the application based at least in part on the behavior detected;
propagating the security categorization issued for the application tag to a set of storage controllers; and
executing by at least one storage controller a responsive action based at least in part on the security categorization issued for the application tag.

2. The computer-implemented method of claim 1, wherein the method further comprises issuing the security categorization for the application tag based on composite evidentiary data collected by a subset of the set of storage controllers.

3. The computer-implemented method of claim 1, wherein the method further comprises updating the security categorization for the application tag based on a consensus between a subset of set of storage controllers.

4. The computer-implemented method of claim 1, wherein the responsive action comprises at least one of a non-disruptive defensive action and a disruptive defensive action.

5. The computer-implemented method of claim 4, wherein the non-disruptive defensive action comprises a sending a notification to a host deploying the application, wherein the notification comprises details related to the security categorization issued for the application tag corresponding to the component of the application.

6. The computer-implemented method of claim 4, wherein the non-disruptive defensive action comprises sending a notification to a security tool within a client’s environment, wherein the notification comprises details related to the security categorization issued for the application tag at application granularity.

7. The computer-implemented method of claim 4, wherein the non-disruptive defensive action comprises capturing a snapshot of volumes that are mapped to a host that the application tag is originating from.

8. The computer-implemented method of claim 4, wherein the non-disruptive defensive action comprises preventing new host volume mappings from a host that the application tag is originating from.

9. The computer-implemented method of claim 4, wherein the non-disruptive defensive action comprises rejecting a write command from the application tag.

10. The computer-implemented method of claim 4, wherein the disruptive defensive action comprises taking volumes offline that are mapped to a host that the application tag is originating from.

11. The computer-implemented method of claim 4, wherein the disruptive defensive action comprises logging out a host deploying the application corresponding to the application tag each time a command is received from the application.

12. The computer-implemented method of claim 4, wherein the disruptive defensive action comprises blocking access from the application to a network storage location.

13. A computer program product comprising one or more computer readable storage media, and program instructions collectively stored on the one or more computer readable storage media, the program instructions executable by a processor to cause the processor to perform operations comprising:
receiving an application tag identifying a workload received from an application;
sampling application workload data related to the application;
comparing the workload data sampled to an expected workload pattern;
detecting behavior corresponding to the application based on a result of comparing the workload data sampled to the expected workload pattern;
issuing a security categorization for the application tag corresponding to the component of the application based at least in part on the behavior detected;
propagating the security categorization issued for the application tag to a set of storage controllers; and
executing by at least one storage controller a responsive action based at least in part on the security categorization issued for the application tag.

14. The computer program product of claim 13, wherein the stored program instructions are stored in a computer readable storage device in a data processing system, and wherein the stored program instructions are transferred over a network from a remote data processing system.

15. The computer program product of claim 13, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

16. The computer program product of claim 13, further comprising issuing the security categorization for the application tag based on composite evidentiary data collected by a subset of the set of storage controllers.

17. The computer program product of claim 13, further comprising updating the security categorization for the application tag based on a consensus between a subset of the set of storage controllers.

18. The computer program product of claim 13, wherein the responsive action comprises at least one of a non-disruptive defensive action and a disruptive defensive action.

19. A computer system comprising a processor and one or more computer readable storage media, and program instructions collectively stored on the one or more computer readable storage media, the program instructions executable by the processor to cause the processor to perform operations comprising:
receiving an application tag identifying the workload received from a host-side application;
sampling application workload data related to the application;
comparing the workload data sampled to an expected workload pattern;
detecting behavior corresponding to the application based on a result of comparing the workload data sampled to the expected workload pattern;
issuing a security categorization for the application tag corresponding to the component of the application based at least in part on the behavior detected;
propagating the security categorization issued for the application tag to a set of storage controllers; and
executing by at least one storage controller a responsive action based at least in part on the security categorization issued for the application tag.

20. The computer system of claim 19, further comprising issuing the security categorization for the application tag based on composite evidentiary data collected by a subset of the set of storage controllers.
